(19) United States
(12) Patent Application Publication
(10) Pub. No.: US 2014/0148743 A1
(43) Pub. Date: May 29, 2014

(54) Massage Fitness Apparatus for Waist, Abdomen, and Back

(71) Applicant: Jue-Yao Chen, Erlin Township (TW)

(72) Inventor: Jue-Yao Chen, Erlin Township (TW)

(21) Appl. No.: 13/684,728

(22) Filed: Nov. 26, 2012

(51) Int. Cl. A61H 15/00

(52) U.S. Cl. CPC A61H 15/0078
USPC 601/116

(57) ABSTRACT

A massage fitness apparatus for waist, abdomen, and back contains: a frame; a back massaging assembly disposed in the frame; a kneading and swinging portion fixed on a lower end of the frame, the kneading and swinging portion having a first motor for driving a gear assembly by which a rotary shaft is driven, and the rotary shaft having two eccentric rollers mounted on two ends of the rotary shaft, each eccentric roller having a belt mount axially fixed on an eccentric peg thereof; a belt, two ends of which are inserted through a cover and fixed on two belt mounts. Thereby, when the belt is tied around user's waist and abdomen, it drives the first motor, and then the two eccentric rollers swing to drive the belt to knead and swing the user's waist and abdomen, thus obtaining a massage purpose.

### FIELD OF THE INVENTION

The present invention relates to a. massage fitness apparatus, and more particularly to a massage fitness apparatus for waist, abdomen, and back which allows massaging user's back and kneading and swinging user's waist and abdomen simultaneously.

### BACKGROUND OF THE INVENTION

A conventional massage fitness apparatus is only used to massage user's back or only used to knead and swing user's waist and abdomen. However, due to people always sit on an office chair for a long time, they will have growing waist and abdomen and an intensive back. If people hope to keep the waist and the abdomen in a good shape and to release the back, they have to purchase a massage fitness apparatus for kneading and swinging the waist and the abdomen and to buy another back massager for massing the back, thus having a high purchase cost and two different of massage fitness apparatuses.

The present invention has arisen to mitigate and/or obviate the afore-described disadvantages.

### SUMMARY OF THE INVENTION

The primary object of the present invention is to provide a massage fitness apparatus for waist, abdomen, and back which allows massaging user's back and kneading and swinging user's waist and abdomen simultaneously

To obtain the above objective, a massage fitness apparatus for waist, abdomen, and back provided by the present invention contains:

a frame;

a movable back massaging assembly disposed in the frame;

a kneading and swinging portion fixed on a lower end of the frame, the kneading and swinging portion having a first motor for driving a gear assembly by which a rotary shaft is driven, and the rotary shaft having two eccentric rollers mounted on two ends of the rotary shaft, each eccentric roller having a belt mount axially fixed on an eccentric peg thereof;

a belt, two ends of which are inserted through a cover and fixed on two belt mounts;

such that when the belt is tied around user's waist and abdomen, it drives the first motor, and then the two eccentric rollers swing to drive the belt to knead and swing the user's waist and abdomen, thus obtaining a massage purpose.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a front plan view showing the assembly of a massage fitness apparatus for waist, abdomen, and back according to a preferred embodiment of the present invention.

FIG. 2 is a perspective view showing the assembly of the massage fitness apparatus for the waist, the abdomen, and the back according to the preferred embodiment of the present invention.

FIG. 3 is a perspective view showing the assembly of the massage fitness apparatus for the waist, the abdomen, and the back except form a frame according to the preferred embodiment of the present invention.

FIG. 4 is a perspective view showing the exploded components of the massage fitness apparatus for the waist, the abdomen, and the back according to the preferred embodiment of the present invention.

FIG. 5 is a perspective view showing the exploded components of a kneading and swinging portion of the massage fitness apparatus for the waist, the abdomen, and the back according to the preferred embodiment of the present invention.

FIG. 6 is a perspective view showing the exploded components of a movable back massaging assembly of the massage fitness apparatus for the waist, the abdomen, and the back according to the preferred embodiment of the present invention.

FIG. 7 is a perspective view showing the massage fitness apparatus of the present invention is applied in a back cushion of an office chair.

FIG. 8 is a perspective view showing the massage fitness apparatus of the present invention is applied in a seatback of a massage chair.

FIG. 9 is a perspective view showing the massage fitness apparatus of the present invention is applied in a back pad of a massage cushion.

### DETAILED DESCRIPTION OF THE PREFERRED EMBODIMENTS

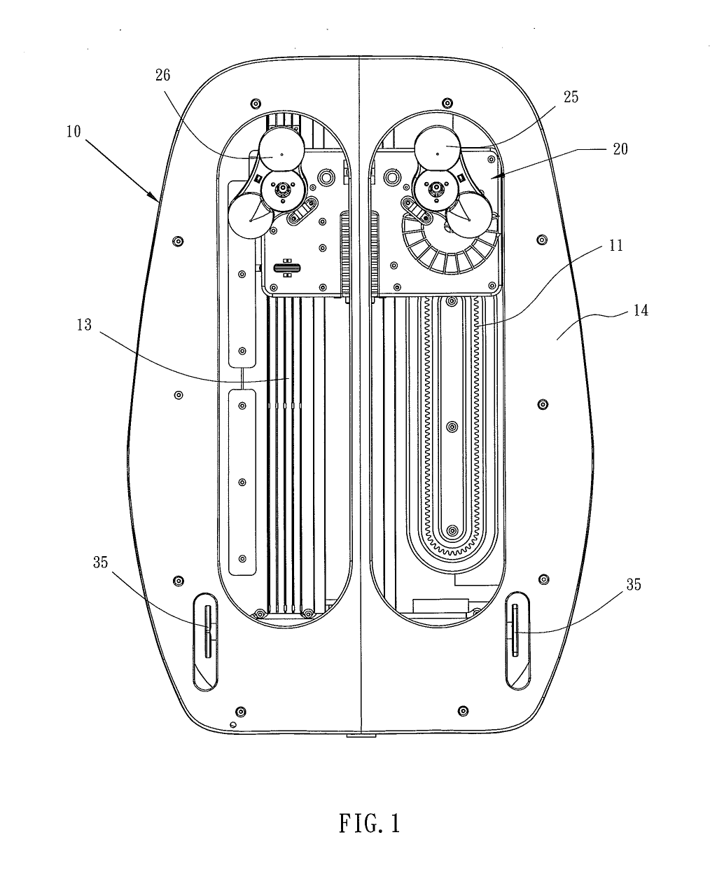

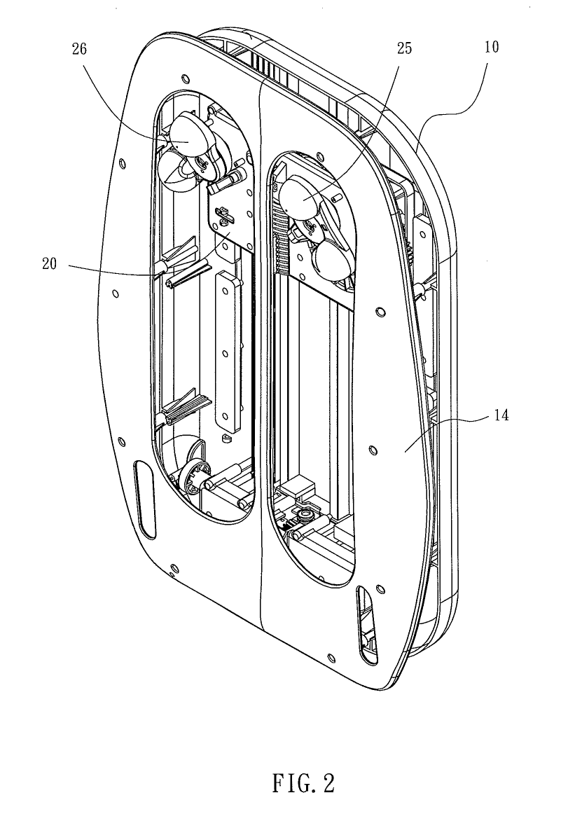

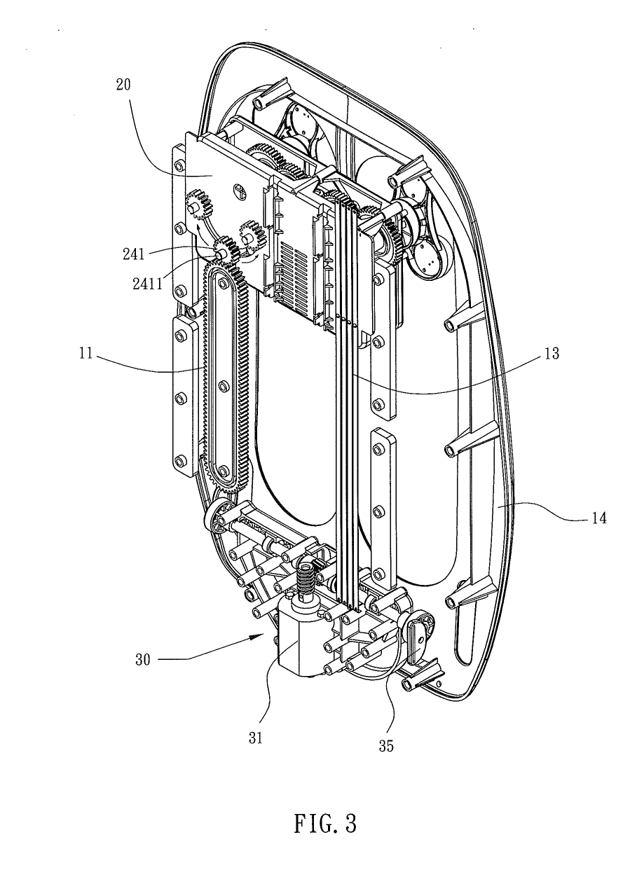

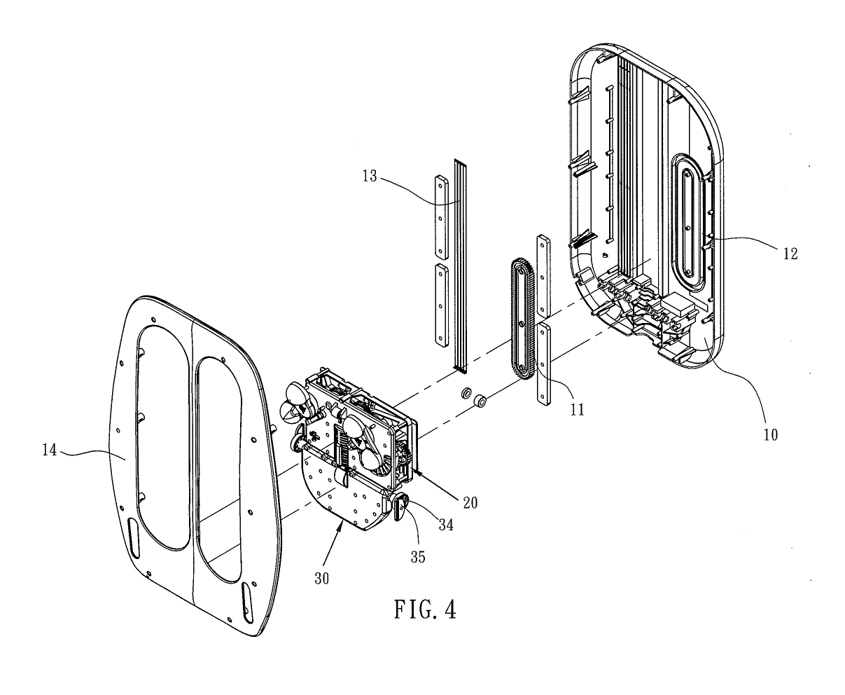

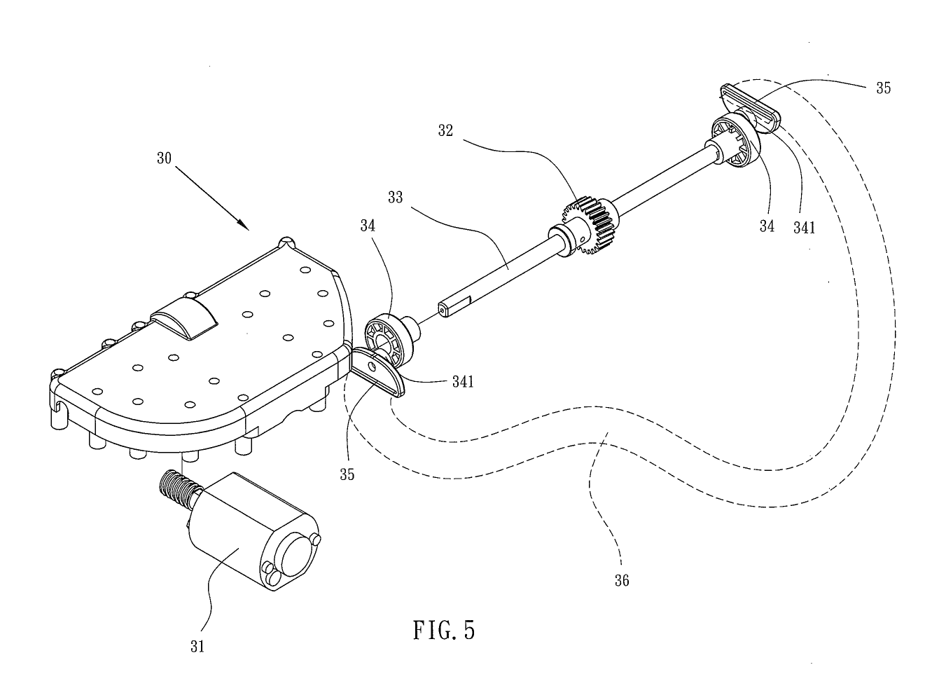

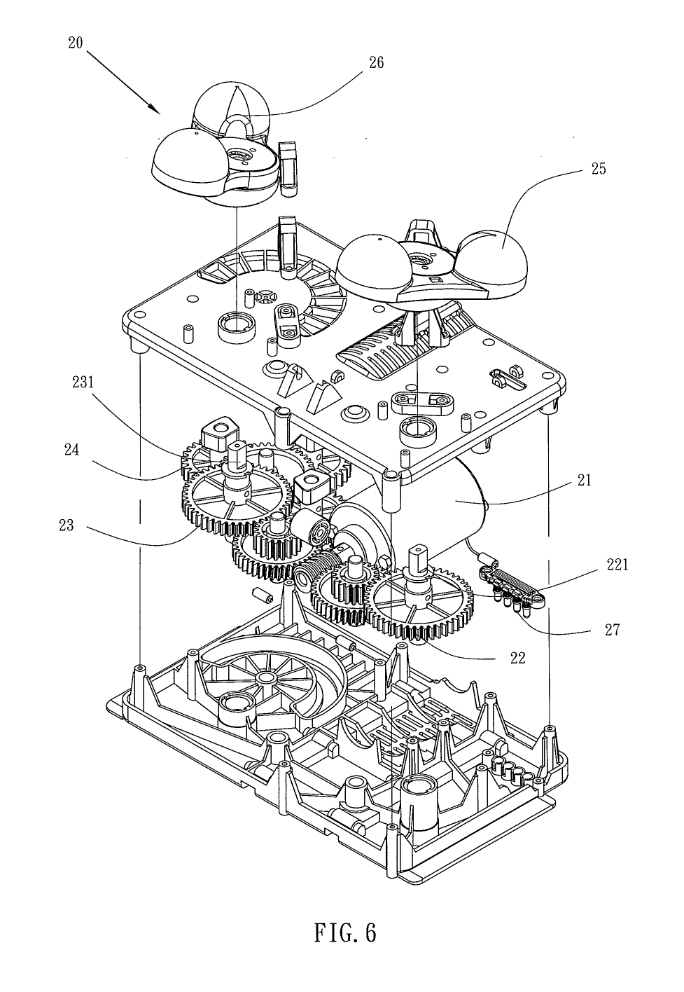

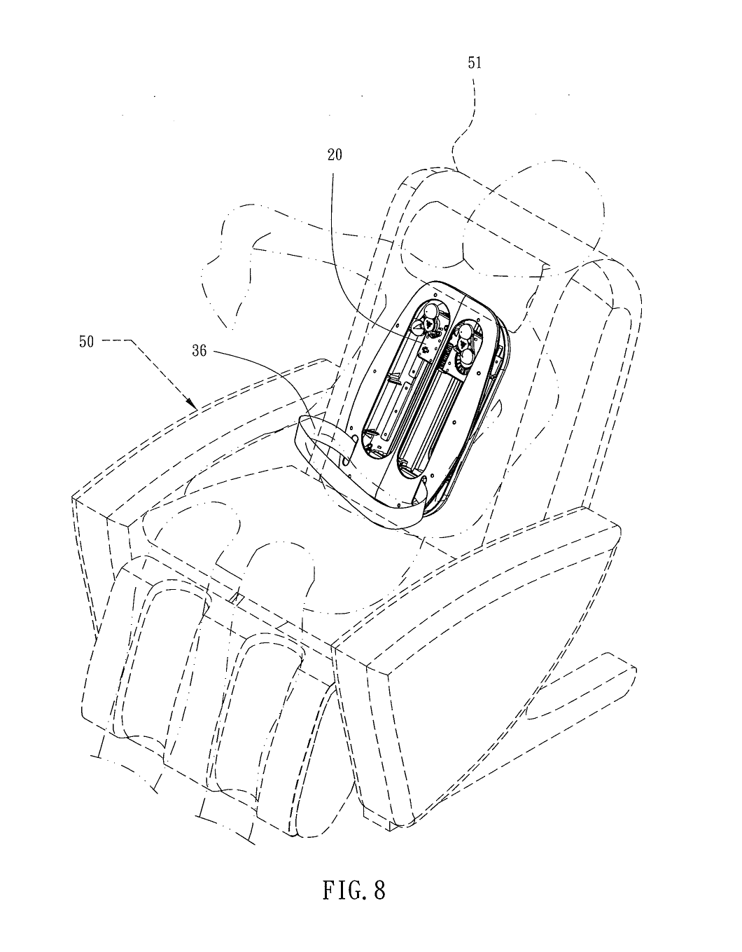

With reference to FIGS. 1-8, a massage fitness apparatus for waist, abdomen, and back according to a preferred embodiment of the present invention comprises:

a frame 10 including a movable back massaging assembly 20 disposed therein, a kneading and swinging portion 30 fixed on a lower end thereof; the kneading and swinging portion 30 having a first motor 31 for driving a gear assembly 32 by which a rotary shaft 33 is driven, and the rotary shaft 33 having two eccentric rollers 34 mounted on two ends of the rotary shaft 33, each eccentric roller 34 having a belt mount 35 axially fixed on an eccentric peg 341 thereof; a belt 36, two ends of which are inserted through a cover 14 and fixed on two belt mounts 35. Thereby, when the belt 36 is tied around user's waist and abdomen, it drives the first motor 31, and then the two eccentric rollers 34 swing to drive the belt 36 to knead and swing the user's waist and abdomen, thus obtaining a massage purpose.

The frame 10 further includes a toothed portion 11, a groove 12, and a plurality of electricity conducting straps 13.

The movable back massaging assembly 20 includes an electricity conduct portion 27 for electrically conducting with the plurality of electricity conducting straps 13, and includes a second motor 21 for driving a first gear set 22, a second gear set 23, and a third gear set 24, and includes two first massaging heads 25 and two second massaging heads 26 mounted on an upper side of the movable back massaging set 20, wherein a first transmission stem 221 and a second transmission stem 231 move upwardly to drive the two first massaging heads 25 and the two second massaging heads 26 so as to has a kneading massage, and the third gear set 24 moves downwardly to mesh with and drive the toothed portion 11, wherein a pillar 2411 of a last gear 241 of the third gear set 24 retains in the groove 12 so that the last gear 241 guides the toothed portion 11, hence the toothed portion 11 does not disengage from the third gear set 24, such that the toothed portion 11 guides the second motor 21 to drive the movable back massaging assembly 20 so that the movable back massaging assembly 20 reciprocately moves upward and downward, thus having a back kneading massage.

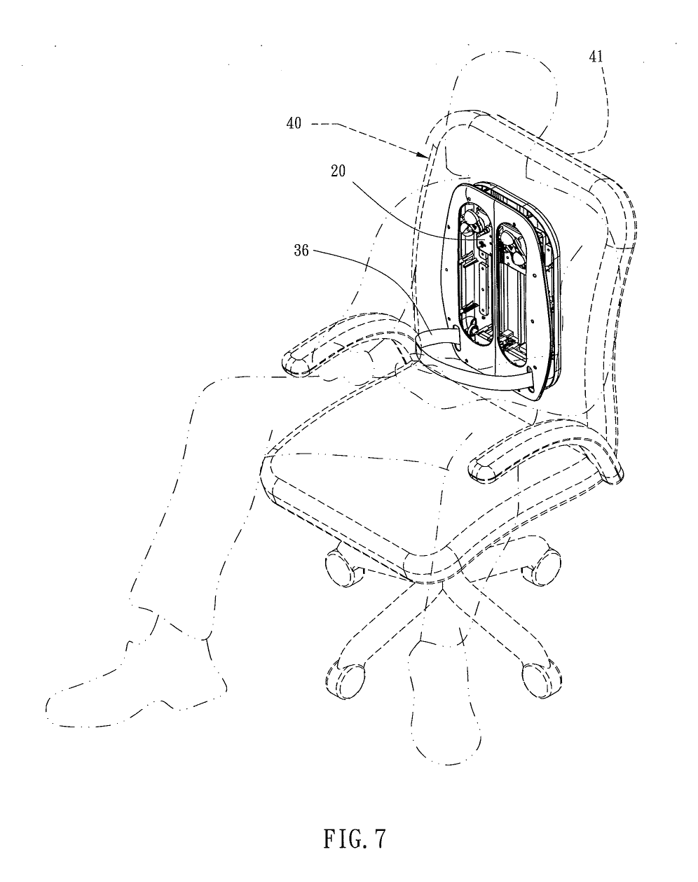

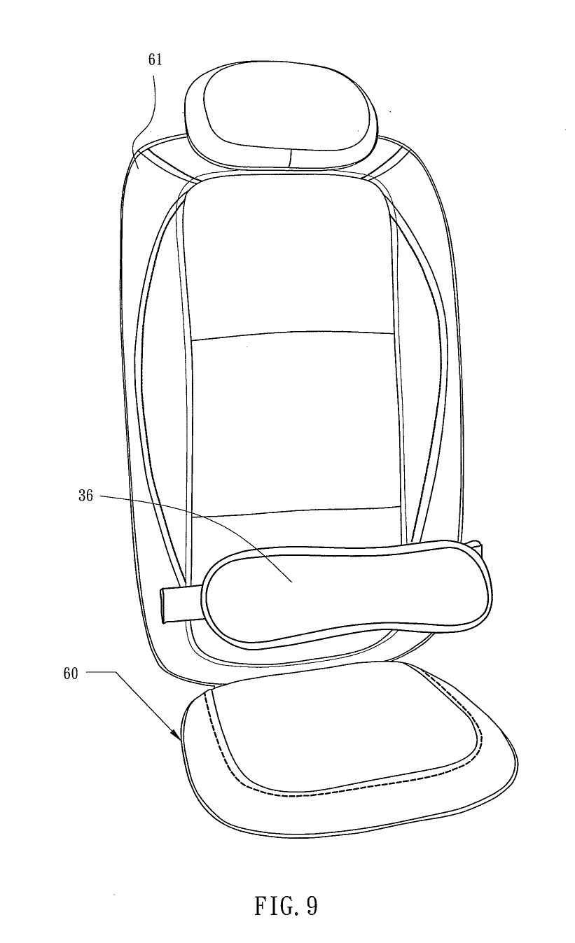

Referring further to FIGS. 7-9, the massage fitness apparatus for the present invention are applied in a back portion of a chair, such as a back cushion 41 of an office chair 40 or a seatback 51 of a massage chair 50, or a back pad 61 of a massage cushion 60. Thereby, the movable back massaging assembly 20 is capable of massaging user's back, and the belt 36 of the kneading and swinging portion 30 is tied on the user's waist and abdomen so that the kneading and swinging portion 30 kneads and swings the user's waist and abdomen, thus massaging the user's back and kneading and swinging the user's waist and abdomen simultaneously.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A massage fitness apparatus for waist, abdomen, and back comprising:
a frame;
a movable back massaging assembly disposed in the frame;
a kneading and swinging portion fixed on a lower end of the frame, the kneading and swinging portion having a first motor for driving a gear assembly by which a rotary shaft is driven, and the rotary shaft having two eccentric rollers mounted on two ends of the rotary shaft, each eccentric roller having a belt mount axially fixed on an eccentric peg thereof;
a belt, two ends of which are inserted through a cover and fixed on two belt mounts;
such that when the belt is tied around user's waist and abdomen, it drives the first motor, and then the two eccentric rollers swing to drive the belt to knead and swing the user's waist and abdomen, thus obtaining a massage purpose.

2. The massage fitness apparatus for the waist, the abdomen, and the back as claimed in claim 1, wherein the frame further includes a toothed portion, a groove, and a plurality of electricity conducting straps.

3. The massage fitness apparatus for the waist, the abdomen, and the back as claimed in claim 2, the movable back massaging assembly includes an electricity conduct portion for electrically conducting with the plurality of electricity conducting straps, and includes a second motor for driving a first gear set, a second gear set, and a third gear set, and includes two first massaging heads and two second massaging heads mounted on an upper side of the back massaging set, wherein a first transmission stem and a second transmission stem move upwardly to drive the two first massaging heads and the two second massaging heads so as to has a kneading massage, and the third gear set moves downwardly to mesh with and drive the toothed portion, wherein a pillar of a last gear of the third gear set retains in the groove so that the last gear guides the toothed portion, hence the toothed portion does not disengage from the third gear set, such that the toothed portion guides the second motor to drive the back massaging assembly so that the back massaging assembly reciprocately moves upward and downward, thus having a back kneading massage.
